(19) United States
(12) Patent Application Publication
(10) Pub. No.: US 2025/0166434 A1
(43) Pub. Date: May 22, 2025

(54) MULTI-MODAL MODEL FOR TRAFFIC ACCIDENT ANALYSIS

(71) Applicant: Technology Innovation Institute - Sole Proprietorship LLC, Masdar City (AE)

(72) Inventors: Kebin WU, Masdar City (AE); Wenbin LI, Masdar City (AE); Xiaofei XIAO, Masdar City (AE); Ebtesam ALMAZROUEI, Masdar City (AE)

(73) Assignee: Technology Innovation Institute - Sole Proprietorship LLC, Masdar City (AE)

(21) Appl. No.: 18/954,967

(22) Filed: Nov. 21, 2024

Related U.S. Application Data
(60) Provisional application No. 63/622,129, filed on Jan. 18, 2024.
(60) Provisional application No. 63/601,526, filed on Nov. 21, 2023.

(51) Int. Cl. G07C 5/08; G06N 20/00; G06Q 50/40

(52) U.S. Cl. CPC G07C 5/0866; G06N 20/00; G06Q 50/40

(57) ABSTRACT

Disclosed herein are system, method, and computer program product embodiments for a model of traffic accident analysis, which incorporates multi-modal input data to automatically reconstruct accident process video with dynamics details and further provide multi-task analysis with multi-modal outputs.

### CROSS REFERENCE TO RELATED APPLICATIONS

This application claims benefit of and priority to U.S. Application. No. 63/601,526, filed Nov. 21, 2023 and U.S. Application. No. 63/622,129, filed Jan. 18, 2024, each of which is incorporated by reference in its entirety.

### FIELD

Embodiments of the present disclosure are generally related to a system for traffic accident analysis, which incorporates multi-modal input data to reconstruct the traffic accident using video and vehicle dynamics, and furthermore provide analysis via multi-modal outputs.

### BACKGROUND

Traffic accident analysis is pivotal for enhancing public safety and developing road regulations. Some approaches are often constrained by manual analysis processes, subjective decisions, uni-modal inputs and outputs, as well as privacy issues related to sensitive data.

### BRIEF SUMMARY

Disclosed herein are system, apparatus, device, method, and/or computer program product embodiments, and/or combinations and sub-combinations thereof, for accident analysis, which incorporates multi-modal input data to reconstruct the traffic accident using video and vehicle dynamics, and furthermore provide analysis via multi-modal outputs.

In embodiments, a system for traffic accident analysis is disclosed. The system may incorporate a multi-modal input data to reconstruct the traffic accident using video and vehicle dynamics, and furthermore provide analysis via multi-modal outputs. The system may utilize multi-modal prompts, reinforcement learning, hybrid training, and an edge-cloud split configuration to perform the traffic accident analysis.

Embodiments of the present disclosure include a computer-implemented method for accident analysis. The computer-implemented method receives one or more encoded sensor readings, where the one or more encoded sensor readings include data regarding a traffic accident. The method also includes aligning the one or more encoded sensor readings. The aligned one or more encoded sensor readings correspond to the traffic accident. The method further includes generating, by a multi-modal model, an output associated with the traffic accident using the one or more encoded sensor readings.

Embodiments of the present disclosure further include a system with a memory and at least one processor coupled to the memory. The at least one processor is configured to receive one or more encoded sensor readings, where the one or more encoded sensor readings include data regarding a traffic accident. The at least one processor is further configured to align the one or more encoded sensor readings, where the aligned one or more encoded sensor readings correspond to the traffic accident. Furthermore, at least one processor is further configured to generate, by a multi-modal model, an output associated with the traffic accident using the one or more encoded sensor readings.

Embodiments of the present disclosure further include a non-transitory computer-readable device having instructions stored thereon that, when executed by at least one computing device, cause the at least one computing device to perform operations that include receiving one or more encoded sensor readings, where the one or more encoded sensor readings include data regarding a traffic accident. The operations include aligning the one or more encoded sensor readings. The aligned one or more encoded sensor readings correspond to the traffic accident. Lastly, the operations include generating, by a multi-modal model, an output associated with the traffic accident using the one or more encoded sensor readings.

### BRIEF DESCRIPTION OF THE DRAWINGS

The accompanying drawings are incorporated herein and form a part of the specification.

FIG. 1 depicts an accident environment, according to embodiments.

FIG. 2 depicts a diagram of an accident analysis environment, according to embodiments.

FIG. 3 depicts a diagram of a training environment, according to embodiments.

FIG. 4 depicts a diagram of the relationship between the input modalities, a multi-modal model, and output modalities, according to embodiments.

FIG. 5 depicts a diagram of a multi-modal model, according to embodiments.

FIG. 6 depicts a diagram of a transformer block, according to embodiments.

FIG. 7 depicts a flowchart illustrating a method for using an accident analysis system, according to embodiments.

FIG. 8 depicts a flowchart illustrating a method for updating an accident analysis system using reinforcement learning, according to embodiments.

FIG. 9 depicts a flowchart illustrating a method for gathering, formatting, and transmitting sensor data, according to embodiments.

FIG. 10 depicts a flowchart illustrating a method for generating and training on a set of pseudo-labeled data, according to embodiments.

FIG. 11 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

It is noted that references in the specification to “one embodiment,” “an embodiment,” “an example embodiment,” and “exemplary” indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

In some embodiments, the terms “about” and “substantially” can indicate a value of a given quantity that varies within 20% of the value (e.g., ±1%, ±2%, ±3%, ±4%, ±5%, ±10%, ±20% of the value). These values are merely examples and are not intended to be limiting. The terms “about” and “substantially” can refer to a percentage of the values as interpreted by those skilled in relevant art(s) in light of the teachings herein.

It is to be understood that the phraseology or terminology herein is for the purpose of description and not of limitation, such that the terminology or phraseology of the present specification is to be interpreted by those skilled in relevant art(s) in light of the teachings herein.

The following disclosure describes aspects of an accident analysis system. Specifically, the present disclosure describes an accident analysis system that includes a multi-modal model trained using various types of input modalities. Each input modality may include data from a variety of sensors. For example, the multi-modal model may be trained using video, photos, witness reports, GPS data, and inertial measurement unit (IMU) data. The accident analysis system may be configured to analyze an accident and generate a multi-modal output regarding the accident. For example, the accident analysis system may output an insurance claim characterizing the accident, and a 3D video reconstruction of the accident. A benefit of the accident analysis system, among others, is the ability to receive and align multiple types of sensor data that all correspond to the same accident, to produce the analysis. For example, the accident analysis system may receive dash camera footage, CCTV footage, and vehicle IMU data, analyze the inputs, and determine that they all correspond to the same accident.

The accident analysis system may also perform feature alignment such that each received input is mapped to the same representation space. Other machine learning systems are uni-modal, meaning that they are data type specific. For example, one machine learning model may be used to perform object detection in images while another machine learning model is configured to receive text and perform language translation. For accident analysis, there is a need to be able to accept various types of inputs (e.g., sensor data) to produce a comprehensive analysis. In embodiments, this is accomplished by projecting the sensor data from each modality into the same representation space.

Another benefit of the accident analysis system is the ability to produce an output that can include multiple modality types. For example, the accident analysis system may be configured to output text and video components corresponding to the same accident. For example, the accident analysis system may generate a traffic management recommendation, a 3D video reconstruction, and an insurance claim for the accident. In embodiments, this may be accomplished by storing decoding layers for each output type. Before generating the output, the multi-modal model can pass the analysis through a decoding layer corresponding to the requested output modality.

In embodiments, the accident analysis system may be trained using different learning algorithms, such as supervised, self-supervised, and weakly-supervised learning algorithms. Utilizing multiple learning algorithms may be beneficial because it allows the accident analysis system to learn from an increased number of sources. Additionally, it makes the accident analysis system more robust since the quality of data in each of these methods likely varies.

There may be privacy concerns regarding capturing sensor data and transmitting it to an accident analysis system. For example, it is possible that sensitive data may be intercepted by a malicious actor during the transmission. Additionally, since the accident analysis system is likely to save received sensor data for further training, there is a concern that any received sensitive data may be stored indefinitely. These challenges may be overcome by processing the sensor data at edge systems, ensuring any sensitive or private data is not transmitted to the accident analysis system. Additionally, removing sensitive or private data reduces the amount of information that has to be processed, thus making accident analysis system more efficient.

An additional benefit of the accident analysis system is offloading analysis to edge systems. Certain tasks, such as sensor data capture, processing, and tokenization, may occur on edge systems (e.g., sensor devices). Performing these operations at the edge system reduces the amount of processing performed by the accident analysis system.

Provided herein are system, apparatus, device, method and/or computer program product embodiments, and/or combinations and sub-combinations thereof, for traffic accident analysis, which incorporates multi-modal input data to reconstruct the traffic accident using video and vehicle dynamics, and furthermore provide analysis via multi-modal outputs.

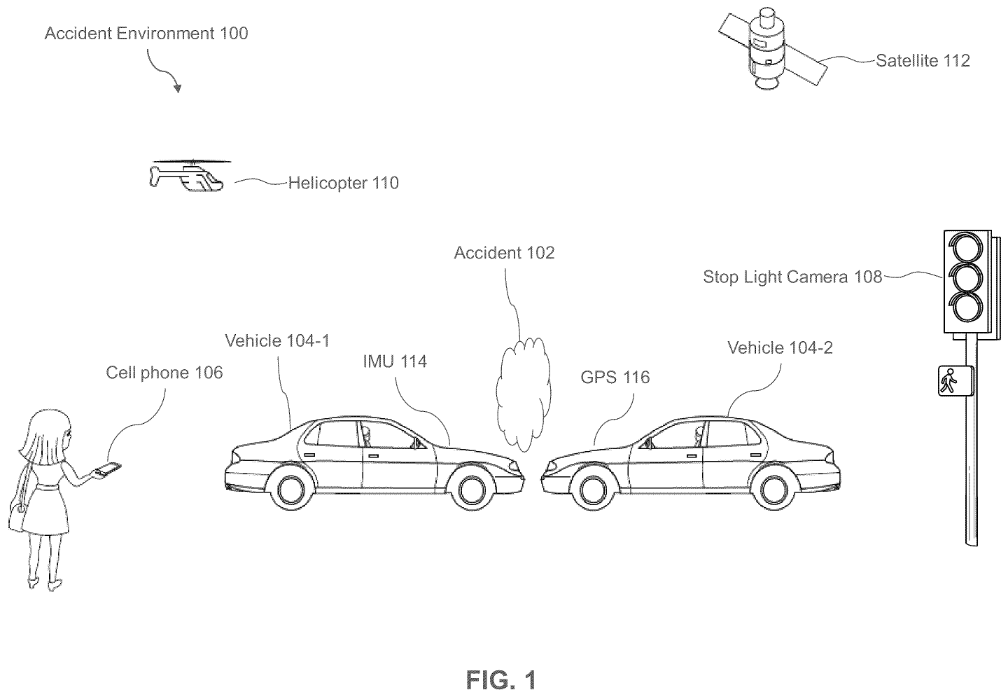

FIG. 1 depicts accident environment 100, according to embodiments. Accident environment 100 includes accident 102 and vehicles 104-1 and 104-2. In embodiments, accident 102 may be a collision between vehicles 104-1 and 104-2. Vehicle 104-1 may be a red car and vehicle 104-2 may be a blue car. Accident environment 100 may also include various sensors, such as cell phone 106, stop light camera 108, helicopter 110, satellite 112, inertial measurement unit (IMU) 114, and GPS 116. Each of these sensors may have captured data relating to accident 102. For example, stop light camera 108 may have been recording video and audio, thus capturing events before, during, and after accident 102. In addition, cell phone 106 may have taken images and video of the aftermath of accident 102. IMU 114 may have captured acceleration and direction data from vehicle 104-1 before, during, and after accident 102. GPS 116 may have been recording the location of vehicle 104-2 before, during, and after accident 102.

Other information, in addition to the sensor data, may be available. For example, historical traffic data associated with the location of accident 102 may be used to look for collisions similar to accident 102. Data associated with vehicles 104-1 and 104-2, such as their make, model, and year, may be accessed. For example, this information may be used to determine whether there is a defect or recall associated with vehicles 104-1 or 104-2. Although FIG. 1 depicts the sensors listed above, the disclosure is not limited to this example.

After accident 102, various tasks may need to be performed. For example, a driver of vehicle 104-1 may need to file an insurance claim. As part of this process, the insurance provider may need to determine which vehicle was at fault, vehicle 104-1 (e.g., the red car) or vehicle 104-2 (e.g., the blue car). Additionally, the manufacturer of vehicle 104-1 may be concerned with whether a manufacturing defect caused the accident. Thus, there is a need to gain a comprehensive understanding of what caused accident 102 as well as how it unfolded. To accomplish this, available data regarding accident 102 can be collected and analyzed to generate a report detailing accident 102. Data regarding accident 102 may come from various sensors, such as cell phone 106, stop light camera 108, helicopter 110, satellite 112, IMU 114, and GPS 116. Data may also come in the form of statements from the drivers of vehicles 104-1 and 104-2, as well as from any bystander, such as from the owner of cell phone 106.

Data regarding accident 102 may be collected and analyzed by an accident analysis system. The accident analysis system may input the collected data and apply the collected data to a machine learning model. The machine learning model may be trained on sensor data from accidents, such as accident 102, to perform accident related analysis. The machine learning model may be a single machine learning model or multiple machine learning models. For example, the machine learning model may have been trained via accident video recordings to determine which vehicle was at fault. Here, the video captured by stop light camera 108 may be used as input to identify whether the driver of the red car (vehicle 104-1) or blue car (vehicle 104-2) was at fault. The accident analysis system may use some or all of the received sensor data to generate the analysis. For example, the model may consider acceleration and direction data from IMU 114 as well as location data from GPS 116 in addition to the video data, to make its determination as to which driver was at fault.

As stated above, the accident analysis system may analyze an accident, such as accident 102, for various tasks. Based on the task, the accident analysis system may create various output modalities. For example, if the driver of vehicle 104-1 is using accident analysis system to file an insurance claim, the system may use the sensor data to create the claim, including information such as: (1) involved parties; (2) statement of facts; (3) party at fault; and (4) estimated damages. In addition, the accident analysis system may be used by the municipality where accident 102 occurred to re-route traffic. For example, if accident 102 occurred in an intersection, the accident analysis system may be used to determine whether the intersection is blocked, and if so, create a re-routing/detour plan for the area.

In embodiments, the accident analysis system may be used to create a 3D reconstruction of accident 102. The accident analysis system may analyze and fuse the received sensor data, as well as extrapolate from the sensor data, to generate the reconstruction. The reconstruction may include visual depictions and text descriptions of events that occurred prior to accident 102, such as road conditions, historic traffic patterns, and vehicle data. The reconstruction may further include audio narration of the video. The reconstruction may also depict the paths of vehicle 104-1 and vehicle 104-2 leading up to accident 102. This may be the result of combining multiple sensor data. For example, part of the depiction may come from the footage captured by stop light camera 108, and another part may be created based on the combination of data from GPS 116 in vehicle 104-2 and a dash camera located within vehicle 104-2. The reconstruction may also include captions narrating the events of accident 102. For example, the captions may describe what is occurring in each scene as well as other information not discernable from the video such as vehicle kinematics from IMU 114 and road conditions.

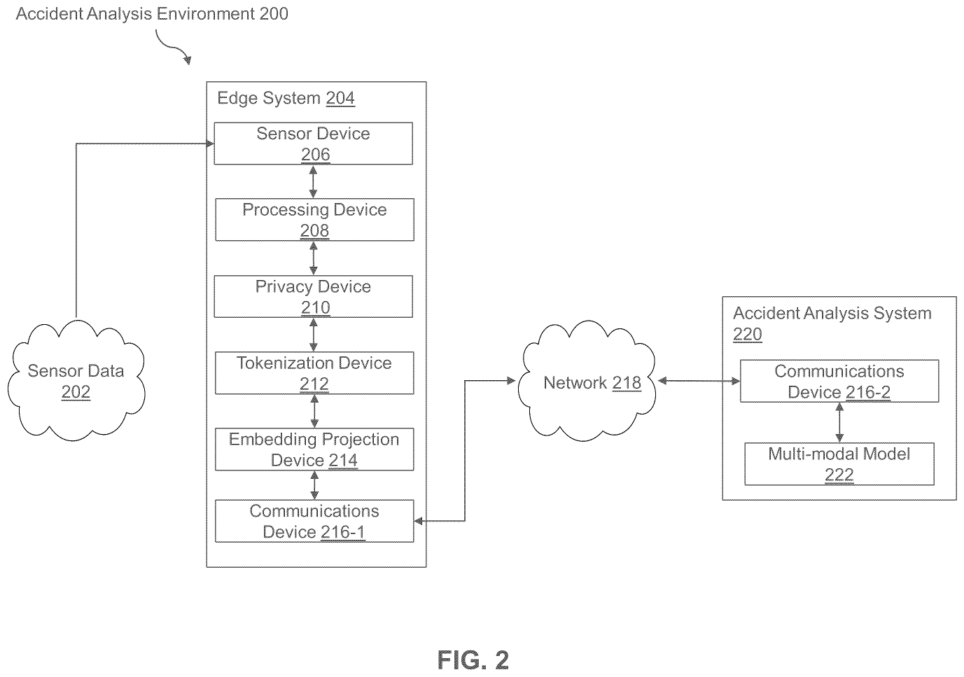

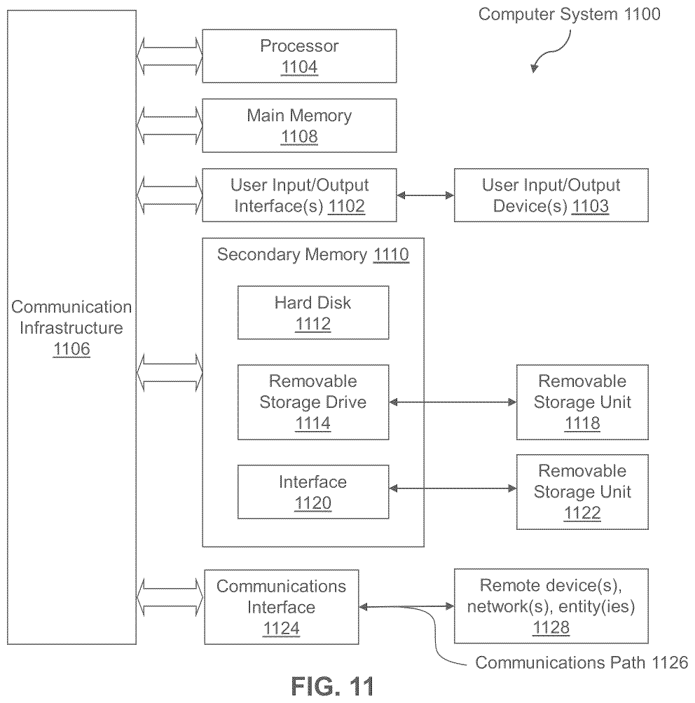

FIG. 2 depicts a diagram of an accident analysis environment 200, according to embodiments. Accident analysis environment 200 may include sensor data 202, edge system 204, network 218, and accident analysis system 220. Edge system 204 may be a computer system, such as computer system 1100 described with reference to FIG. 11. For example, edge system 204 may be implemented using one or more servers and/or databases. In embodiments, edge system 204 may be implemented using a computing device, such as a desktop workstation, laptop or notebook computer, netbook, tablet, smart phone, and/or other computing device. Edge system 204 may be any device capable of using or accessing a sensor to gather data.

Edge system 204 may include sensor device 206, processing device 208, privacy device 210, tokenization device 212, embedding projection device 214, and communications device 216-1. Sensor device 206 may include one or more sensors for gathering sensor data 202.

Sensor data 202 may include, but is not limited to: (a) pre and post-accident site photos, (b) CCTV camera recordings, (c) dashcam footage, (d) statements about the accident (e.g., from drivers, witness), (e) movement dynamics data (e.g., Inertial Measurement Units (IMU) data), (f) location data (e.g., GPS data), (g) date and time, (h) road condition data (e.g., wet, dry, and icy), (i) historical traffic data, (j) vehicle details (e.g., vehicle type, vehicle make, vehicle model, and vehicle year), (k) insurance information, (l) vehicle sensor data, and (m) audio data. For example, sensor device 206 may include a camera and sensor data 202 may be video and/or image data. Referring to FIG. 1, edge system 204 may be cell phone 106, and sensor device 206 may be a camera on cell phone 106. As another example, edge system 204 may be vehicle 104-1, and sensor device 206 may be an IMU on vehicle 104-1. Here, the corresponding sensor data 202 may be vehicle 104-1's acceleration and directional data. Sensor device 204 may transmit the sensor data to processing device 208.

Processing device 208 may be responsible for removing noisy input from sensor data 202 collected by sensor device 206. Noisy input may be sensor data 202 that is unusable by accident analysis system 220. For example, edge system 204 may be a car involved in an accident and sensor device 206 may include a dashcam capturing video (e.g., sensor data 202) during the accident. In this example, the video during and after the accident may be noisy due to the impact of the accident (e.g., snowflake screen). This may be due to a number of factors, such as smoke, fire, glass, debris, and/or damage to the dashcam itself. Processing device 208 may be configured to remove the noise from the input so that the input can be analyzed and reconstructed.

Processing device 208 may also be configured to remove irrelevant and/or sparse sensor data 202. Irrelevant sensor data 202 may refer to sensor data 202 that does not capture information regarding the accident. For example, if the lens of a dash camera was covered during an accident, the accompanying footage would not be useful for accident analysis and therefore can be removed by processing device 208. Sparse sensor data 202 may refer to sensor data 202 where significant portions are useless. In this instance, processing device 208 may be configured to remove the useless sections. For example, sensor data 202 may be dash camera footage of an accident. Processing device 208 may remove all footage up to a predetermined time period (e.g., ten minutes) prior to the accident.

Removing irrelevant and sparse sensor data 202 may improve the performance of accident reconstruction and analysis in two ways, according to embodiments. First, because accident reconstruction and analysis is resource intensive, reducing the size of the inputs that are analyzed reduces the amount of computation performed by accident analysis system 220. Second, the machine learning applied by accident analysis system 220 relies on the input to the system to make its determination. Therefore, providing only relevant sensor data 202 helps ensure that accident analysis system 220 produces the correct output. Processing device 208 may be enabled or disabled. If disabled, processing device 208 does not remove noisy, irrelevant, and sparse data from sensor data 202. This may be advantageous in a scenario where edge system 204 has limited computing resources.

Privacy device 210 may analyze the output of processing device 210. Privacy device 210 may implement a privacy policy specifying information to remove from sensor data 202. For example, privacy device 210 may implement a privacy policy that removes all vehicle GPS data up to a predetermined time period (e.g., one minute) prior to the accident. In embodiments, privacy module 210 may implement a privacy policy that protects bystander privacy. For example, privacy module 210 may apply a face detection filter to photos and video and apply a blurring filter (e.g., a Gaussian filter) that alters the pixel values of the detected faces so that they are unrecognizable. The output of privacy device 210 may include one or more floating point numbers.

In embodiments, the privacy policy may be defined so that no data is altered and/or removed from sensor data 202. For example, the privacy policy may state that vehicle IMU data does not need to be inspected because it is unlikely to include sensitive data. IMU data likely includes information only relating to a car, such as vehicle 104-1, and therefore is unlikely to include private information about the driver or a bystander.

When privacy device 210 removes sensitive data from sensor data 202, it may append a tag to the altered data identifying the modality of sensor data 202. This may be beneficial so that accident analysis system 220 can determine what modality sensor data 202 belongs to. Privacy module 210 may be updated at edge system 204. In embodiments, accident analysis system 220 may send a privacy policy to edge system 204 via network 218.

Tokenization device 212 may be used to break up the output of privacy device 210 into discrete components. The discrete components may be indexed with token identifiers. Different tokenization algorithms may be used based on the modality of sensor data 202. For example, text data may be tokenized using a first algorithm, and image data may be tokenized using a second algorithm. The tokenization algorithm may use machine learning models as part of the tokenization.

Models used by tokenization device 212 may be changed or updated. For example, tokenization device 212 may use a model trained to tokenize text based on the frequency of character groupings occurring in a vocabulary. In this example, the model may be re-trained on a new vocabulary to generate new or updated tokens. In embodiments, models at tokenization device 212 may need to be trained to tokenize each type of sensor data 202 modality (e.g., image, text, video, etc.). In embodiments, tokenization device 212 may utilize pre-trained models. The pre-trained models may be fine-tuned (e.g., re-trained) to optimize their performance for a particular use case.

Embedding projection device 214 may be configured to encode the output of tokenization device 212. Embedding projection device 214 may take an input and convert it into an output. The output may be in a different format than the input. For example, if an input is formatted as text-based tokens, each token may be converted into a numeric vector to be processed by accident analysis system 220. In this example, embedding projection device 214 may maintain a vocabulary of known words and their associated embeddings stored as vectors. When embedding projection device 214 receives output from tokenization device 212, it may convert each token to its associated embedding value.

Embedding projection device 214 may produce embeddings that retain the meaning of sensor data 202. For example, if sensor data 202 is text, embedding projection device 214 may encode each word of the text into numerical vectors, such that similar words in the text have similar vector values. In this example, words such as “tree” and “grass” would have more similar values than “tree” and “airplane.” Embedding projection device 214 may perform different encoding techniques for different input modalities. Embedding projection device 214 may use machine learning models to perform the encoding techniques so that the meaning and context of the original sensor data is maintained. The machine learning models may be re-trained. In embodiments, embedding projection device 214 may use pre-trained models. This may be beneficial so that the models can be used immediately, without having to be trained. In embodiments, embedding projection device 214 may fine-tune (e.g., re-train) the models to improve their performance.

Communications device 216-1 may be responsible for communicating with accident analysis system 220 via network 218. Communications device 216-1 may include any suitable network interface capable of transmitting and receiving data, such as a modem, an Ethernet card, a communications port, or the like. Communications device 216-1 may be able to transmit data using any wireless transmission standard, such as Wi-Fi, Bluetooth, cellular, or any other suitable wireless transmission. Communications device 216-1 may compress the output of embedding projection device 214 prior to transmission.

Network 218 may be any type of computer or telecommunications network capable of communicating data, for example, a local area network, a wide-area network (e.g., the Internet), or any combination thereof. The network may include wired and/or wireless segments.

In embodiments, the accident analysis system described above with regard to FIG. 1, may be accident analysis system 220. Accident analysis system 220 may be a computer system, such as computer system 1100 described with reference to FIG. 11. For example, accident analysis system 220 may be implemented using one or more servers and/or databases. In some embodiments, accident analysis system 220 may be implemented using a computing device, such as a desktop workstation, laptop or notebook computer, netbook, tablet, smart phone, and/or other computing device. In some embodiments, accident analysis system 220 may be implemented as an application in an enterprise computing system.

Accident analysis system 220 may include communications device 216-2 and multi-modal model 222. Communications device 216-2 may be configured to communicate with edge system 204 via network 218. Accident analysis system 220 may receive transmissions from edge system 204. In embodiments, communications device 216-2 may receive the output from embedding projection device 214, sent by communications device 216-1. The received output may include one or more floating point numbers.

Multi-modal model 222 may be a machine learning model (e.g., a single machine learning model or multiple machine learning models) trained to perform accident analysis and reconstruction. For example, multi-modal model 222 may be trained on videos of car accidents to create a 3D reconstruction of the accident, where the 3D reconstruction includes captions detailing what is occurring throughout the reconstruction. Multi-modal model 222 may be configured to receive, train on, and analyze sensor data 202 from various modalities. Multi-modal model 222 may be configured to perform detection and/or analysis of sensor data 202 that multi-modal model 222 has either not previously seen (e.g., zero-shot learning) or only seen once before (e.g., one-shot learning). In embodiments, multi-modal model 222 may be a transformer model. In embodiments, multi-modal model 222 may perform the processing, tokenization, and encoding described above with respect to edge system 204. In embodiments, multi-modal model 222 may implement a privacy policy as described above with respect to privacy device 210.

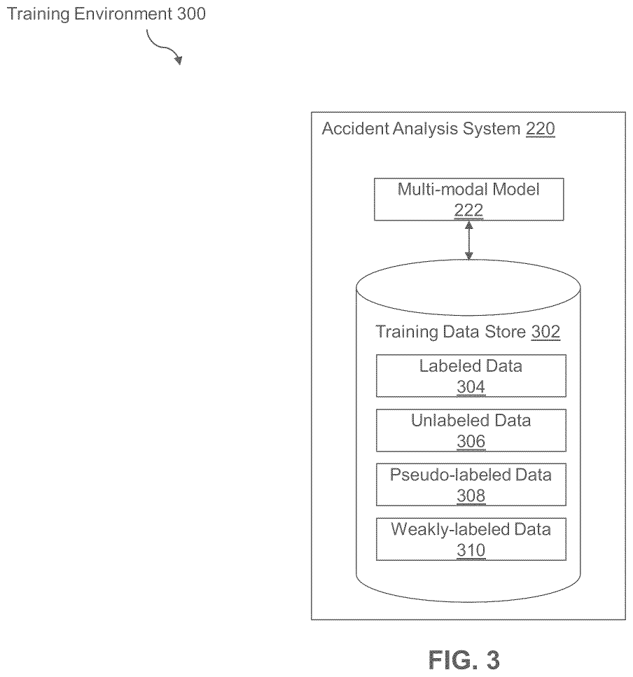

FIG. 3 depicts a diagram of a training environment 300, according to embodiments. Training environment 300 may include accident analysis system 220, multi-modal model 222, and training data store 302. Training data store 302 may store training data to teach a machine learning model at accident analysis system 220 to analyze accidents and produce an accurate multi-modal output. In embodiments, the machine learning model may be multi-modal model 222. Training data store 302 may be stored on a memory storage device.

Training data store 302 may be storage for training data used by multi-modal modal 222. Training data store 302 may be a database. Training data store 302 may be updated with new training data examples. In embodiments, training data store 302 may be updated with sensor data 202 received from edge system 204. Training data store 302 may group training data examples by event. For example, data from cell phone 106, stop light camera 108, vehicles 104-1 and 104-2, IMU 114, and GPS 116 may all be linked to accident 102.

Since a goal of accident analysis system 220 is to analyze accidents using data from various sources, each of these training data examples is grouped together so that accident analysis system 220 can learn features from each, how they relate to each other, and how they can be used to produce a requested analysis regarding the accident (e.g., an insurance claim and a 3D reconstruction). Training data store 302 may also include simulated training data. For example, footage of a car accident taken from a video game may be just as informative and useful for accident analysis as an actual video of a real-world accident. Therefore, training data store 302 may include simulated training data in addition to real-world training data examples.

Training data store 302 may include labeled data 304, unlabeled data 306, pseudo-labeled data 308, and weakly-labeled data 310. Accident analysis system 220 may use each set of training data alone, or in combination with any other set. For example, accident analysis system 220 may first use labeled data 304 to train a machine learning model (e.g., multi-modal model 222) (e.g., a single machine learning model or multiple machine learning models) for accident analysis. Accident analysis system 220 may use the trained model to generate labels for a set of unlabeled data (e.g., pseudo-labeled data) and re-train on the labeled and pseudo-labeled data. In embodiments, accident analysis system 220 may use unlabeled data 306 for self-supervised learning. In embodiments, accident analysis system 220 may train a machine learning model (e.g., a single machine learning model or multiple machine learning models) on labeled data 304, unlabeled data 306, pseudo-labeled data 308, and weakly-labeled data 310. The result of this process is that accident analysis system 220 has access to additional examples than if it only used labeled data 304, and it ultimately becomes more robust due to having seen additional examples.

Labeled data 304 may include training data examples along with ground truth data. The ground truth data may be a label describing what multi-modal model 222 should learn from that training data. For example, if the training data is an image of busy city block including accident 102, the label may be a bounding box drawn around vehicles 104-1 and vehicle 104-2. Labeled data 304 may include training data from various modalities, such as image, video, audio, and text. Although labeled data 304 may be the best source to train a model, such as multi-modal model 222, it may be expensive to generate because each example needs to be annotated or labeled.

Unlabeled data 306 may include training data that is unlabeled. There may be large amounts of sensor data capturing accidents for which there are no associated labels (e.g., truth data describing what occurred). For example, stop light camera 108 may generate recordings that are stored by the municipality. However, these recordings may not include bounding boxes or captions describing the recordings.

Accident analysis system 220 may use unlabeled training data, such as unlabeled training data 306, in various ways. For example, accident analysis system 220 may generate pseudo-labels for unlabeled data 306. The pseudo-labels may be accident analysis system 220′s prediction of what the ground truth of the unlabeled data example should be. For example, the unlabeled data may be a photo from cell phone 106 of accident 102. Accident analysis system 220 may input the photo and generate a pseudo-label constituting a bounding box around vehicles 104-1 and 104-2.

Accident analysis system 220 may assign a confidence score for each pseudo-label, and only those pseudo-labels with a confidence score above a predefined threshold may be applied to the data sample. For example, the confidence score threshold may be 80%, and accident analysis system 220 may produce a pseudo-label of “car accident, red car at fault” for a CCTV recording with a confidence score of 90%. In this example, because the confidence score is above the confidence score threshold, the pseudo-label would be applied to the CCTV recording sample.

Each example from unlabeled data 306 with a pseudo-label confidence score greater than the threshold may be copied to pseudo-labeled data 308. In embodiments, once the example is copied to pseudo-labeled data 308, the example may be removed from unlabeled data 306 to reduce storage requirements from storing two of the same examples. Examples from unlabeled data 306 with pseudo-labels below the confidence score threshold may remain in unlabeled data 306.

Pseudo-labeled data 308 may be updated periodically. In embodiments, accident analysis system 220 may re-label the examples at pseudo-labeled data 308, after a certain amount of training and validation. For example, the first time pseudo-labeled data 308 is created, the labels may be inaccurate. As accident analysis system 220 trains and becomes more proficient, it would be beneficial to provide updated labels for pseudo-labeled data 308 so they can further improve accident analysis system 220. This may be beneficial to increase the amount of training data accident analysis system 220 has access to.

Unlabeled data 306 may also be used by accident analysis system 220 for self-supervised learning. Self-supervised learning may involve predicting or producing an analysis for part of an input by using a different part or the remainder of the input. This process is designed to help the representation learning for accident analysis system 220.

Self-supervised learning may involve selecting and augmenting a single training sample from unlabeled data 306. For example, unlabeled data 306 may include an image of a car accident, such as accident 102. Accident analysis system 220 may augment (e.g., modify) the image. The augmentation may involve removing portions of the image, rotating the image, segmenting the image and reordering the segments, blurring the image, and/or converting the image from grayscale to color or vice versa. Accident analysis system 220 may create two different augmented versions of the image. Accident analysis system 220 may then be trained to minimize a loss function that maximizes the similarity between the representations of the augmented images. A goal is to recognize that the two images, although augmented, come from the same base image.

Self-supervised learning may also involve masking part of the example and then using accident analysis system 220 to predict the masked portion. For example, the input may be a witness statement describing an accident, such as “I saw the red car run the red light and hit the blue car.” Masking may remove “red car” from the statement, and accident analysis system 220 may be trained to predict that “red car” was removed and should be filled back into the statement. As another example, an image of accident 102 may be modified to remove vehicle 104-1 from the image. Accident analysis system 220 may be trained to reconstruct the image with vehicle 104-1 shown.

Self-supervised learning may improve accident analysis system 220 by forcing it to extract and learn from additional features within each example. For example, if every image that includes a car accident also depicts the vehicles, accident analysis system 220 may associate an “accident” with the presence of vehicles in an image. However, it may be advantageous for accident analysis system 220 to learn other indicators of an accident, such as debris, fire, smoke, vehicle kinematic data, etc. Therefore, by masking (e.g., removing, covering) the vehicles in the training image, accident analysis system 220 may be forced to learn other indicators of an accident. Accident analysis system 220 may use augmentation and masking techniques at the same time or serially.

Weakly-labeled data 310 may be training data with noisy or incomplete labels. Noisy labels may be labels that don't correctly describe the training data. For example, a training data set of images can be constructed by querying an image search engine with the word “monarch” and saving the returned images as the training examples. Some of the images may depict monarch butterflies and others may depict a ruler, such as a king or a queen. Based on the distribution of the returned images, the model can be trained on the returned images. Utilizing weakly-labeled data 310 allows accident analysis system 220 to be trained on a much larger set of data.

Incomplete labels may provide some truth data for the training data example. For example, if the training data is an image of accident 102 and the label should be a bounding box around vehicles 104-1 and 104-2, then an incomplete label may simply be a caption “car accident,” without a bounding box. From this example, a model is informed that the image includes a car accident, but not know exactly where in the image it is. Using weakly labeled data 310 may allow accident analysis system 220 to be more robust since it can access more data to learn from.

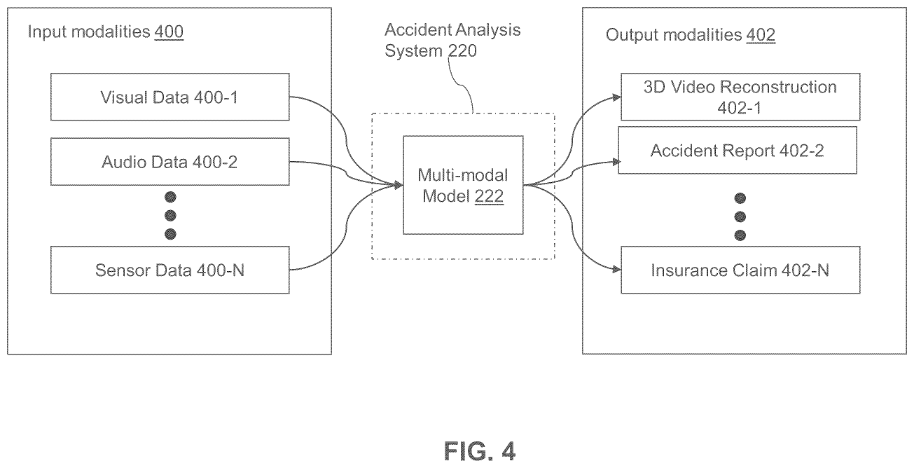

FIG. 4 depicts a block diagram of the relationship between the input modalities 400, multi-modal model 222, and output modalities 402. As discussed above, edge system 204 may include sensor device 206 responsible for gathering sensor data 202. The collected sensor data 202 may be categorized into various input modalities 400. Input modalities 400 may be input to multi-modal model 222 via network 218. For example, images and video may be considered visual data 400-1, whereas audio recordings may be considered audio data 400-2. Although multiple input modalities 400 are depicted, multi- modal model 222 may be configured to generate an output modality 402 without having sensor data from each input modality 400. For example, accident 102 may only have been captured by a CCTV recording from stop light camera 108. In this example, although there is no audio data 400-2 or sensor data 400-N (e.g., GPS or IMU data), multi-modal model 222 may still create an analysis of accident 102.

Multi-modal model 222 may generate a multi-modal output including one or more output modalities 402. The output modalities 402 generated by multi-modal model 222 may be determined by a prompt to multi-modal model 222. The prompt may include an analysis task and requirements for the task. For example, a prompt may include a request to create a 3D reconstruction of a specified accident. The prompt may further include a preferred video length and whether to include captions and audio narration. In this example, the output created by multi-modal model may be a 3D video of the accident. The video may also include text captions or audio describing each scene of the video. Output modalities 402 may include information describing what happened during the accident. For example, output modalities 402 may include 3D video reconstruction 402-1, accident report 402-2, and insurance claim 402-N. Output modalities 402 may further include For example, a 2D reconstructed video of the accident, vehicle dynamics (e.g., location, velocity, direction, braking force, acceleration, and turning angle), and responsibility attribution (e.g., which driver was at fault). Output modalities 402 may also include post-accident tasks, such as traffic reports, traffic management recommendations, and emergency response communications (e.g., automatic 911 call with accident details).

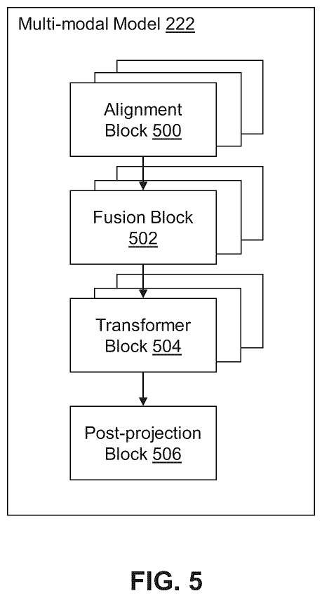

FIG. 5 depicts a diagram of multi-modal model 222, according to embodiments. Multi-modal model 222 may be a machine learning model (e.g., a single machine learning model or multiple machine learning models) configured to perform accident analysis and reconstruction. Multi-modal model 222 may be pre-trained. For example, multi-modal model 222 may be trained prior to installation or initialization within accident analysis system 220. This may be beneficial so that resources do not have to be spent training multi-modal model 222. Multi-modal model 222 may be fine-tuned to improve its performance in particular circumstances. For example, multi-modal model 222 may be pre-trained using an initial training data set that includes examples from various contexts (e.g., movies, shows, books, art, weather data, websites, and news). Multi-modal model 222 may then be fine-tuned for a specific context. For example, multi-modal model 222 may be fine-tuned or re-trained using accident specific data (e.g., CCTV accident recordings, dashcam videos, witness statements, accident scene photos, and vehicle dynamics). Since training a machine learning model such as multi-modal model 222 may be resource intensive, using a pre-trained model may reduce the amount of resources needed to operate accident analysis system 220.

Multi-modal model 222 may include alignment block 500, fusion block 502, transformer block 504, and post-projection block 506. Multi-modal model 222 may include one or more of each of alignment block 500, fusion block 502, and transformer block 504. In embodiments, the order of alignment block 500, fusion block 502, transformer block 504 may change. For example, multi-modal model 222 may be configured such that the output of alignment block 500 is input to transformer block 504, and the output of transformer block 504 is input to fusion block 502. The ordering does not have to be consistent across layers. For example, alignment block 500 may be situated next to fusion block 502.

Alignment block 500 may be configured to perform feature-level alignment. Feature alignment may involve mapping features from different sources to the same internal representation or semantic representation space. In embodiments, the mapping may involve transforming the features from the different sources so that they are of equal dimensions. Feature alignment may be achieved by minimizing a contrastive loss that measures the distance between the embeddings (e.g., encodings) of different modalities. Once aligned, the data may be fused such that it represents a single representation of the data from various modalities. Multi-modal model 222 may include one or more alignment blocks 500.

Fusion block 502 may be configured to receive the output from alignment block 500 and create a single representation that can be processed at once. Fusion block 502 may concatenate each output from alignment block 500. For example, accident 102 may have associated sensor data 202 including images, video, and text. Once sensor data 202 is encoded and aligned, it may be fused together into a single representation. In embodiments, if each sensor data 202 was represented by an individual vector, these vectors may be concatenated or stacked to create a matrix. This may be beneficial so that accident analysis system 220 can learn and leverage data from different sensor modalities. Multi-modal model 222 may include one or more fusion blocks 502.

Transformer block 504 may be configured to generate an analysis and/or prediction based on the received input. Multi-modal model 222 may include one or more transformer blocks 504. Transformer blocks 504 may be stacked such that the output from a first transformer block 504 is used as the input to a second transformer block 504. Post-projection block 506 may be configured to receive output from transformer block 504 and perform various tasks. For example, post-projection block 506 may create a probability distribution from the output of transformer block 504. In embodiments, this may be accomplished by employing a softmax function.

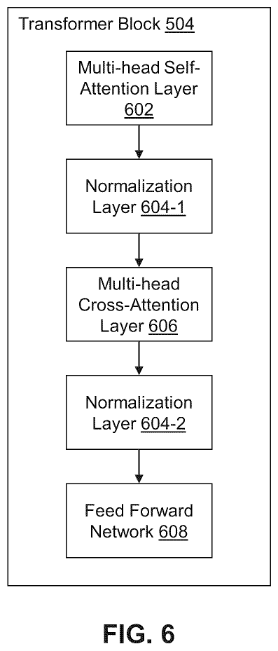

FIG. 6 depicts a diagram of transformer block 504, according to embodiments. Transformer block 504 may include multi-head self-attention layer 602, normalization layer 604-1, multi-head cross-attention 606, normalization layer 604-2, and feed forward network 608.

Self-attention layer 602 may be configured to determine the importance or similarity of each part of an input to every other part. For example, if an input is text, self-attention layer 602 identifies, for each word, the other most relevant word in the text. Transformer block 504 may have multiple self-attention layers 602. Multiple self-attention layers 602 allow the importance of each part of the sensor data to be computed in relation to every other part, in parallel. Such an architecture decreases latency and increases the utilization of computer resources.

Normalization layers 604-1 and 604-2 may be used to ensure that outputs of each stage are on the same scale. Transformer block 504 may be configured with multiple normalization layers 604-1 and 604-2 as shown in FIG. 6. Multi-head cross-attention layer 606 may be used to perform the self-attention function described above, but across two or more modalities. For example, multi-head cross-attention layer 606 may receive embeddings corresponding to text and an image, and use features from both modalities to make predictions.

Feed forward network 608 may be applied so that the output of a first transformer block 504 is formatted to be received by a second transformer block 504.

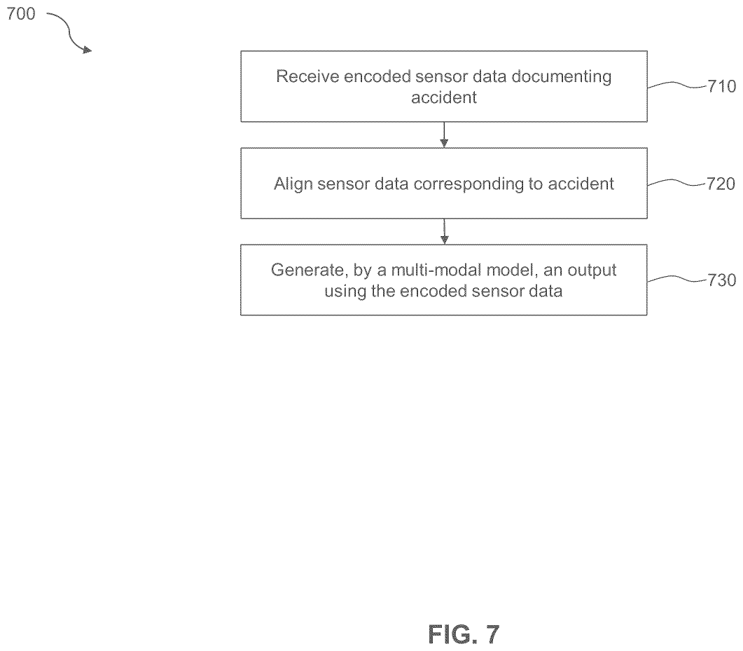

FIG. 7 depicts a flowchart illustrating a method 700 for using an accident analysis system, according to embodiments. Method 700 is described with reference to FIG. 2; however, method 700 is not limited to that example embodiment.

In embodiments, accident analysis system 220 may utilize method 700 to receive and align sensor data including information relating to an accident. Accident analysis system 220 uses this sensor data to produce an output including an analysis of the accident. While method 700 is described with reference to accident analysis system 220, method 700 may be executed on any computing device, such as the computer system described with reference to FIG. 11 and/or processing logic that may include hardware (e.g., circuitry, dedicated logic, programmable logic, microcode), software (e.g., instructions executing on a processing device), or a combination thereof.

It is to be appreciated that not all operations may be needed to perform the disclosure provided herein. Further, some of the operations may be performed simultaneously, or in a different order than shown in FIG. 7, as would be understood by a person of ordinary skill in the art.

At operation 710, accident analysis system 220 may receive encoded sensor readings data. The encoded sensor readings may include data regarding the accident. For example, the encoded sensor readings may include data documenting the accident (e.g., footage of an accident). The encoded sensor readings may come from various sources, such as CCTV video, bystander video, satellite imagery, witness statements, and/or vehicle data. The received readings may have any potentially private information removed. For example, if the sensor readings are a video, the faces of any bystanders may be blurred out to protect their privacy.

At operation 720, the received sensor readings may be aligned. Alignment may synchronize data from various modalities to ensure that they represent the same event or phenomenon. This operation may be necessary to generate a comprehensive analysis of the accident. Alignment may be accomplished by analyzing the received sensor data. For example, two photographs may be aligned to the same accident if they share the same date and were captured within a certain time window (e.g., each photo was captured within 15 minutes of each other). Here, the encoded sensor readings may be aligned by time so that the aligned encoded sensor readings correspond to the same accident.

In embodiments, accident analysis system 220 may align the sensor data. For example, two different video feeds may lack time, date, and GPS data to manually align them. Accident analysis system 220 may be used to analyze the contents of the video feeds and determine that they are depicting the same events. For example, one video feed may have captured the accident from a street light camera, such as stop light camera 108, and another video feed may be from a bystander cell phone, such as cell phone 106. Accident analysis system 220 may analyze the contents of the feeds, such as the cars depicted in the accident and nearby objects (e.g., buildings, people, and trees), to determine that the feeds capture the same event. Based on this determination, the video feeds may be aligned.

At operation 730, a multi-modal model (e.g., multi-modal model 222) at accident analysis system 220 generates the requested output. The output may be generated in response to a prompt specifying an accident and describing one or more output tasks. The one or more tasks may each correspond to a format (e.g., a video and a report). For example, a prompt may be “Produce an insurance claim for the driver of the red car involved in the accident on Jan. 1, 2023 at 9:30 am EST at 800 16th St NW, Washington, DC 20006.” In embodiments, the prompt may include multi-modal inputs, such as video, photographs, and/or audio samples. For example, a prompt may include a video of an accident along with a request to caption the video.

The multi-modal model may use the one or more encoded sensor readings and the one or more prompts to generate the output describing the accident. As stated above, accident analysis system 220 is trained to perform accident analysis. Based on the prompts and inputs, accident analysis system 220 analyzes the inputs to build a reconstruction or simulation of the accident. Accident analysis system 220 uses this analysis to create the requested output. For example, if the requested output was a statement of facts, accident analysis system 220 can create a text file listing each event that occurred and a corresponding time stamp. In embodiments, if the requested output was a 3D video, accident analysis system 220 can use the input data to create a step-by-step reconstruction of what happened during the accident.

Generating the output modalities may involve a decoding process. As described above, the received sensor data is tokenized and projected to a numeric representation space of the sensor data. After going through feature alignment (e.g., alignment block 500), fusion (e.g., fusion block 502), and transformation (e.g., transformer block 504) in the multi-modal model (e.g., multi-modal model 222), a new set of features with rich and high-level semantic information may be obtained. Therefore, before outputting the results, a post-projection operation translates the output into a human-readable format. In embodiments, this may be performed by post-projection block 506. For example, if the requested output was an accident report, a post-projection operation (e.g., post-projection block 506) in accident analysis system 220 decodes the encoded vectors extracted from previous blocks into their corresponding textual representations.

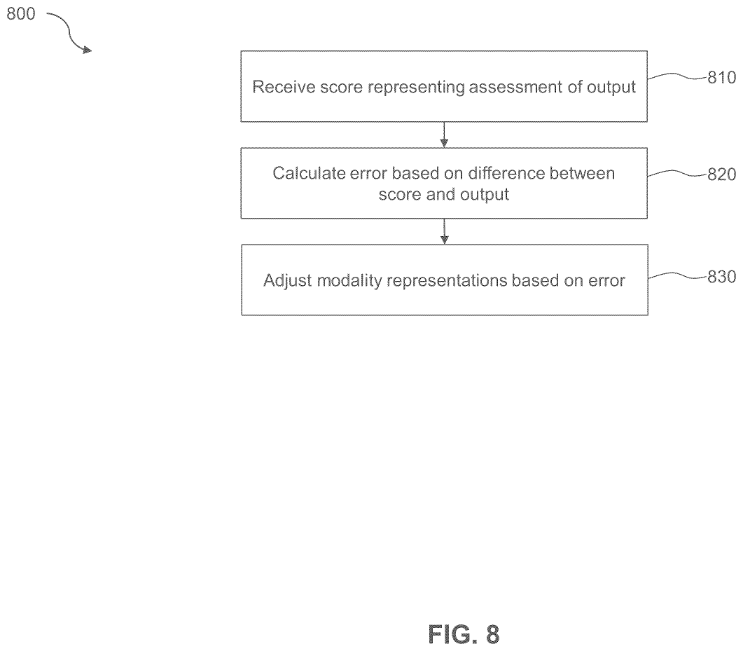

FIG. 8 depicts a flowchart illustrating method 800 for updating accident analysis system 220 using reinforcement learning, according to embodiments. Method 800 is described with reference to FIG. 2; however, method 800 is not limited to that example embodiment.

In embodiments, accident analysis system 220 may utilize method 800 to update a machine learning model based on received assessments of the produced output. While method 800 is described with reference to accident analysis system 220, method 800 may be executed on any computing device, such as the computer system described with reference to FIG. 11 and/or processing logic that may include hardware (e.g., circuitry, dedicated logic, programmable logic, and microcode), software (e.g., instructions executing on a processing device), or a combination thereof.

It is to be appreciated that not all operations may be needed to method 800 of FIG. 8. Further, some of the operations may be performed simultaneously, or in a different order than shown in FIG. 8, as would be understood by a person of ordinary skill in the art.

At operation 810, accident analysis system 220 receives a score representing an assessment of the output. For example, accident analysis system 220 may receive a CCTV recording of an accident between a red car and a blue car, along with a question asking which driver was at fault. Accident analysis system 220 may use a multi-modal model, such as multi-modal model 222, to determine that the red car was at fault. In response to this determination, the party requesting the analysis may compare the determination from accident analysis system 220 to their own assessment of the recording. For example, it may become apparent after watching the recording that, in fact, the blue car was at fault. In this example, the requesting party may provide a binary assessment and notate that accident analysis system 220 was incorrect. In embodiments, the assessment may be more detailed. For example, accident analysis system 220 may have correctly analyzed the video by tracking both the red and blue car throughout the CCTV recording and was only wrong regarding the fault. Here, the assessment may state that the object detection (e.g., the vehicle tracking) was correct, but the ultimate determination as to which party was at fault was incorrect. The assessment may also include a subjective component. For example, the assessment may state that the analysis was factually correct, but all or part of the analysis was unhelpful. In this example, the analysis may have included a factually correct 3D reconstruction of the analysis, but may have included captions that obscured parts of the video.

At operation 820, accident analysis system 220 may compute an error based on the difference between the output and the received assessment.

At operation 830, accident analysis system 220 may adjust modality representations based on the computed error. Using the example above, if the 3D accident recreation video included factual errors, accident analysis system 220 may use the computed error to adjust weights associated with the 3D video modality.

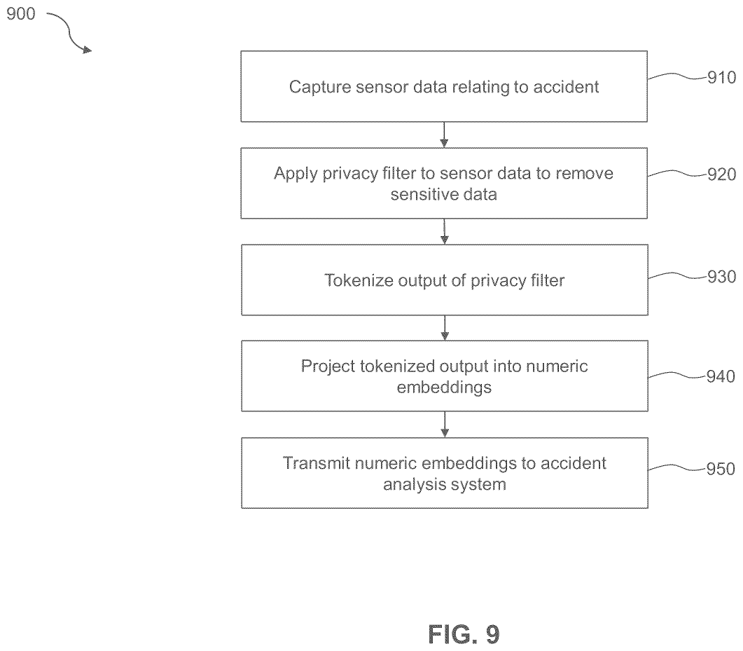

FIG. 9 depicts a flowchart illustrating method 900 for gathering, formatting, and transmitting sensor data, according to embodiments. Method 900 is described with reference to FIG. 1 and FIG. 2; however, method 900 is not limited to those example embodiments. Method 900 may be performed by edge device 204. In embodiments, edge device 204 may be cell phone 106.

While method 900 is described with reference to edge system 204, method 900 may be executed on any computing device, such as the computer system described with reference to FIG. 11 and/or processing logic that may include hardware (e.g., circuitry, dedicated logic, programmable logic, and microcode), software (e.g., instructions executing on a processing device), or a combination thereof.

It is to be appreciated that not all operations may be needed to perform method 900 of FIG. 9. Further, some of the operations may be performed simultaneously, or in a different order than shown in FIG. 9, as would be understood by a person of ordinary skill in the art.

At operation 910, sensor data relating to an accident is captured. For example, stop light camera 108 may be recording when accident 102 occurs. In embodiments, the vehicles involved in the accident may have sensors capturing data. For example, vehicle 104-2 may have a GPS tracking vehicle 104-2's location.

At operation 920, a privacy filter is applied to the sensor data to remove any sensitive data. For example, privacy device 210 may apply the privacy filter. The privacy filter may be defined by a privacy policy that specifies which sensitive data to remove from accident data. The privacy filter may be sent to the sensor by accident analysis system 220. In embodiments, the sensor may have a predefined privacy filter. For example, the privacy filter may be configured to remove faces of individuals involved in accident 102 from any photos or video. In embodiments, if the sensor captured location data, the privacy filter may be applied to remove any location data preceding the accident. The privacy policy and filter may be applied before any other processing (e.g., tokenization, and encoding) is performed. Applying a privacy filter at the sensor is beneficial to prevent any sensitive data from having to be sent to accident analysis system 220.

At operation 930, the output of the privacy filter is tokenized. Tokenization may be used to break up an input into discrete components. The discrete components may be indexed with token identifiers. Different tokenization algorithms may be used based on the modality of sensor data 202. For example, text data may be tokenized using a first algorithm, and image data may be tokenized using a second algorithm. The tokenization algorithms may use machine learning models as part of the tokenization.

At operation 940, the tokenized output is projected into numeric embeddings. The projecting may involve taking an input and converting it into a differently formatted output. For example, if an input is formatted as text, the text may be converted into a numeric vector to be processed by accident analysis system 220. In this example, a lookup table may be used to convert each letter into a number. In embodiments, if the input is an image, a pre-trained model may be used to generate an embedding for each pixel or block of pixels within the image.

At operation 950, the tokenized and projected data is sent to accident analysis system 220. The encoded data may be sent via a wired or wireless network (e.g., network 218).

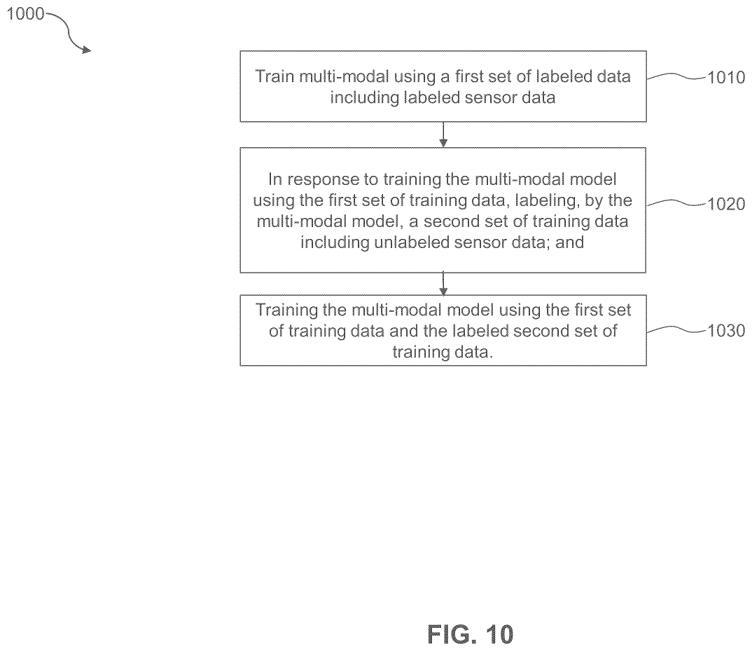

FIG. 10 depicts a flowchart illustrating a method 1000 for generating and training on a set of pseudo-labeled data, according to embodiments. Method 1000 is described with reference to FIG. 2; however, method 1000 is not limited to that example embodiment.

In embodiments, accident analysis system 220 may utilize method 1000 to generate labels for unlabeled training data. The foregoing description describes an embodiment of the execution of method 1000 with respect to accident analysis system 220. While method 1000 is described with reference to accident analysis system 220, method 1000 may be executed on any computing device, such as the computer system described with reference to FIG. 11 and/or processing logic that may include hardware (e.g., circuitry, dedicated logic, programmable logic, and microcode), software (e.g., instructions executing on a processing device), or a combination thereof.

It is to be appreciated that not all operations may be needed to perform method 1000 of FIG. 10. Further, some of the operations may be performed simultaneously, or in a different order than shown in FIG. 10, as would be understood by a person of ordinary skill in the art.

At operation 1010, accident analysis system 220 trains a multi-modal model using a first set of labeled training data including sensor data. In embodiments, accident analysis system 220 may train multi-modal model 222. The first set of labeled training data set may include examples from various modalities. For example, the training data set may include images, audio, text, and IMU examples. Each example in the first training data set may include a label. The label may be the truth data associated with what the example depicts. For example, the training data set may include an image of accident 102 and the label may include a bounding box drawn around vehicles 104-1 and 104-2.

Training may involve updating a set of weights (e.g., parameters) at multi-modal model 222. For each training example, accident analysis system 220 may compute an error based on the difference between accident analysis system 220′s output and the training example's label (e.g., ground truth). Accident analysis system 220 may then use the error to update the set of weights. As an example, accident analysis system 220 may be trained to analyze a witness statement to determine which party was at fault. The witness statement may be “I saw the red car run the light and hit the blue car.” Accident analysis system 220 may then be prompted to determine, based on the statement, which driver was at fault. Accident analysis system 220 may generate a probability for each word or set of words, corresponding to whether that word or set of words is correct. Accident analysis system 220 may, incorrectly, state that the blue car was at fault. In this example, accident analysis system 220 may adjust weights associated with “red car” and “blue car,” based on the predicted probability associated with each set of words.

At operation 1020, in response to training the multi-model using the first set of training data, accident analysis system 220 generates pseudo-labels for a second set of unlabeled training data. Accident analysis system 220 may have access to unlabeled training data. The unlabeled data may include captured sensor data that is missing truth data or labels describing what the sensor data depicts. For example, unlabeled data may be a recording captured by stop light camera 108 of accident 102, without any description, captions, or bounding boxes describing the recording. Accident analysis system 220 can be used to produce pseudo-labels for these examples. For example, an unlabeled image may be input to accident analysis system 220. Accident analysis system 220 may use a multi-model to perform object detection within the image and produce the same image with bounding boxes labeling each object in the image. Operation 1020 may be performed in response to a prompt. For example, a set of unlabeled training data along with a request to label the data may be input to accident analysis system 220. In embodiments, accident analysis system 220 may only apply those pseudo-labels with corresponding confidence scores greater than a predefined threshold.

At operation 1030, accident analysis system 220 trains the multi-modal model using the first and second sets of training data. In embodiments, accident analysis system 220 trains multi-modal model 222. Accident analysis system 220 may combine both training sets before training. In embodiments, accident analysis system 220 may train on both training data sets separately.

Method 1000 may improve accident analysis system 220's overall performance because it can be used to build larger training data sets, which may be ultimately used to train a multi-modal model at accident analysis system 220. For example, the first training set may include 1000 examples and the second training set may include 10,000 examples. Of the 10,000 examples in the second training set, accident analysis system 220 may pseudo-label 9,000 examples, where each of the 9,000 pseudo-labels has a confidence score greater than the threshold. Once accident analysis system 220 is trained on the first set and labels the second set, it can train using the 10,000 examples. This makes accident analysis system more robust since it sees additional training examples.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, and pointing devices, which may communicate with communication infrastructure 1106 through user input/output interface(s) 1102.

One or more of processors 1104 may be a graphics processing unit (GPU). In embodiments, a GPU may be a processor that is a specialized electronic circuit designed to process mathematically intensive applications. The GPU may have a parallel structure that is efficient for parallel processing of large blocks of data, such as mathematically intensive data for computer graphics applications, images, and videos.

Computer system 1100 may also include a main or primary memory 1108, such as random access memory (RAM). Main memory 1108 may include one or more levels of cache. Main memory 1108 may have stored therein control logic (e.g., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, and external entities (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, and the Internet. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), and infrastructure as a service (IaaS)); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In embodiments, a tangible, non-transitory apparatus or article of manufacture including a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Additional embodiments can be found in one or more of the following clauses:
1. A method for accident analysis, including: receiving one or more encoded sensor readings, where the one or more encoded sensor readings include data regarding a traffic accident; aligning the one or more encoded sensor readings, where the aligned one or more encoded sensor readings correspond to the traffic accident; and generating, by a multi-modal model, an output associated with the traffic accident using the one or more encoded sensor readings.
2. The method of clause 1, where the multi-modal model is a single machine learning model configured to receive the one or more encoded sensor readings and create the output.
3. The method of clauses 1 and 2, further including defining a privacy policy, where sensitive data is removed from the traffic accident data according to the privacy policy prior to receiving the one or more encoded sensor readings.
4. The method of clauses 1 to 3, where the multi-modal model is configured to receive one or more modalities including a video, photograph, audio, text, inertial measurement unit data, GPS data, weather data, vehicle type, vehicle sensor data, date, and time.
5. The method of clauses 1 to 4, further including: receiving a score representing an assessment of the output; calculating an error based on a difference between the output and the score; and adjusting representations of the one or more modalities using the error.
6. The method of clauses 1 to 5, where the output is a multi-modal output including one or more of a three-dimensional video reconstruction of the traffic accident, an insurance claim, a news report, a traffic report, a traffic management recommendation, and emergency response communications.
7. The method of clauses 1 to 6, further including: training the multi-modal model using a first set of training data, where the first set of training data includes labeled sensor data; generating, based on the trained multi-modal model using the first set of training data, a pseudo-label and a confidence score for the pseudo-label for a second set of training data including unlabeled sensor data; determining that the confidence score corresponding to the pseudo-label is greater than a predefined threshold; applying the pseudo-label to the second set of training data; and training the multi-modal model using the first set of training data and the pseudo-labeled second set of training data.
8. The method of clauses 1 to 7, further including training the multi-modal model using training data including labeled sensor data, pseudo-labeled sensor data, unlabeled sensor data, and weakly-labeled sensor data.
9. A system includes a memory and at least one processor coupled to the memory. The at least one processor is configured to: receive one or more encoded sensor readings, where the one or more encoded sensor readings include data regarding a traffic accident; align the one or more encoded sensor readings, where the aligned one or more encoded sensor readings correspond to the traffic accident; and generate, by a multi-modal model, an output associated with the traffic accident using the one or more encoded sensor readings.
10. The system of clause 9, where the encoded sensor readings comprise one or more floating point numbers, and wherein the at least one processor is further configured to receive the one or more encoded sensor readings from one or more edge systems
11. The system of clauses 9 and 10, where the at least one processor is further configured to define a privacy policy and remove sensitive data from the traffic accident data according to the privacy policy prior to receiving the one or more encoded sensor readings.
12. The system of clauses 9 to 11, where the at least one processor is configured to receive one or more modalities including a video, photograph, audio, text, inertial measurement unit data, GPS data, weather data, vehicle type, vehicle sensor data, date, and time.
13. The system of clauses 9 to 12, where the at least one processor is further configured to: receive a score representing an assessment of the output; calculate an error based on a difference between the output and the score; and adjust representations of the one or more modalities using the error.
14. The system of clauses 9 to 13, where the output includes one or more of a three-dimensional video reconstruction of the traffic accident, an insurance claim, a news report, a traffic report, a traffic management recommendation, and emergency response communications.
15. The system of clauses 9 to 14, where the at least one processor is further configured to: train the multi-modal model using a first set of training data, where the first set of training data includes labeled sensor data; generate, based on the trained multi-modal model using the first set of training data, a pseudo-label and a confidence score for the pseudo-label for a second set of training data including unlabeled sensor data; determine that the confidence score corresponding to the pseudo-label is greater than a predefined threshold; apply the pseudo-label to the second set of training data; and train the multi-modal model using the first set of training data and the pseudo-labeled second set of training data.
16. The system of clauses 9 to 15, where the at least one processor is further configured to train the multi-modal model using training data including labeled sensor data, pseudo-labeled sensor data, unlabeled sensor data, and weakly-labeled sensor data.
17. A non-transitory computer-readable device having instructions stored thereon that, when executed by at least one computing device, cause the at least one computing device to perform operations. The operations include: receiving one or more encoded sensor readings, where the one or more encoded sensor readings include data regarding a traffic accident; aligning the one or more encoded sensor readings by time, where the aligned one or more encoded sensor readings correspond to the traffic accident; and generating, by a multi-modal model, an output associated with the traffic accident using the one or more encoded sensor readings.
18. The non-transitory computer-readable device of clause 17, further including defining a privacy policy, where sensitive data is removed from the traffic accident data according to the privacy policy prior to receiving the one or more encoded sensor readings.
19. The non-transitory computer-readable device of clauses 17 and 18, where the computing device is configured to receive one or more modalities including a video, photograph, audio, text, inertial measurement unit data, GPS data, weather data, vehicle type, vehicle sensor data, date, and time.
20. The non-transitory computer-readable device of clauses 17 to 19, where the output includes one or more of a three-dimensional video reconstruction of the traffic accident, an insurance claim, a news report, a traffic report, a traffic management recommendation, and emergency response communications.

Based on the teachings in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, and methods using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, embodiments can be described using the expression “coupled” and “connected” along with their derivatives. These terms are not necessarily intended as synonyms for each other. For example, embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for accident analysis, comprising:
receiving one or more encoded sensor readings, wherein the one or more encoded sensor readings comprise data regarding a traffic accident;
aligning the one or more encoded sensor readings, wherein the aligned one or more encoded sensor readings correspond to the traffic accident; and
generating, by a multi-modal model, an output associated with the traffic accident using the one or more encoded sensor readings.

2. The method of claim 1, wherein the multi-modal model is a single machine learning model configured to receive the one or more encoded sensor readings and create the output.

3. The method of claim 1, further comprising defining a privacy policy, wherein sensitive data is removed from the traffic accident data according to the privacy policy prior to receiving the one or more encoded sensor readings.

4. The method of claim 1, wherein the multi-modal model is configured to receive one or more modalities comprising a video, photograph, audio, text, inertial measurement unit data, GPS data, weather data, vehicle type, vehicle sensor data, date, and time.

5. The method of claim 3, further comprising:
receiving a score representing an assessment of the output;
calculating an error based on a difference between the output and the score; and
adjusting representations of the one or more modalities using the error.

6. The method of claim 1, wherein the output is a multi-modal output comprising one or more of a three-dimensional video reconstruction of the traffic accident, an insurance claim, a news report, a traffic report, a traffic management recommendation, and emergency response communications.

7. The method of claim 1, further comprising:
training the multi-modal model using a first set of training data, wherein the first set of training data comprises labeled sensor data;
generating, based on the trained multi-modal model using the first set of training data, a pseudo-label and a confidence score for the pseudo-label for a second set of training data comprising unlabeled sensor data;
determining that the confidence score corresponding to the pseudo-label is greater than a predefined threshold;
applying the pseudo-label to the second set of training data; and
training the multi-modal model using the first set of training data and the pseudo-labeled second set of training data.

8. The method of claim 1, further comprising training the multi-modal model using training data comprising labeled sensor data, pseudo-labeled sensor data, unlabeled sensor data, and weakly-labeled sensor data.

9. A system, comprising:
a memory; and
at least one processor coupled to the memory and configured to:
receive one or more encoded sensor readings, wherein the one or more encoded sensor readings comprise data regarding a traffic accident;
align the one or more encoded sensor readings, wherein the aligned one or more encoded sensor readings correspond to the traffic accident; and
generate, by a multi-modal model, an output associated with the traffic accident using the one or more encoded sensor readings.

10. The system of claim 9, wherein the encoded sensor readings comprise one or more floating point numbers, and wherein the at least one processor is further configured to receive the one or more encoded sensor readings from one or more edge systems.

11. The system of claim 9, wherein the at least one processor is further configured to define a privacy policy and remove sensitive data from the traffic accident data according to the privacy policy prior to receiving the one or more encoded sensor readings.

12. The system of claim 9, wherein the at least one processor is configured to receive one or more modalities comprising a video, photograph, audio, text, inertial measurement unit data, GPS data, weather data, vehicle type, vehicle sensor data, date, and time.

13. The system of claim 9, wherein the at least one processor is further configured to:
receive a score representing an assessment of the output;
calculate an error based on a difference between the output and the score; and
adjust representations of the one or more modalities using the error.

14. The system of claim 9, wherein the output comprises one or more of a three-dimensional video reconstruction of the traffic accident, an insurance claim, a news report, a traffic report, a traffic management recommendation, and emergency response communications.

15. The system of claim 9, wherein the at least one processor is further configured to:
train the multi-modal model using a first set of training data, wherein the first set of training data comprises labeled sensor data;
generate, based on the trained multi-modal model using the first set of training data, a pseudo-label and a confidence score for the pseudo-label for a second set of training data comprising unlabeled sensor data;
determine that the confidence score corresponding to the pseudo-label is greater than a predefined threshold;
apply the pseudo-label to the second set of training data; and
train the multi-modal model using the first set of training data and the pseudo-labeled second set of training data.

16. The system of claim 9, wherein the at least one processor is further configured to train the multi-modal model using training data comprising labeled sensor data, pseudo-labeled sensor data, unlabeled sensor data, and weakly-labeled sensor data.

17. A non-transitory computer-readable device having instructions stored thereon that, when executed by at least one computing device, cause the at least one computing device to perform operations comprising:
receiving one or more encoded sensor readings, wherein the one or more encoded sensor readings comprise data regarding a traffic accident;
aligning the one or more encoded sensor readings by time, wherein the aligned one or more encoded sensor readings correspond to the traffic accident; and
generating, by a multi-modal model, an output associated with the traffic accident using the one or more encoded sensor readings.

18. The non-transitory computer-readable device of claim 17, further comprising defining a privacy policy, wherein sensitive data is removed from the traffic accident data according to the privacy policy prior to receiving the one or more encoded sensor readings.

19. The non-transitory computer-readable device of claim 17, wherein the computing device is configured to receive one or more modalities comprising a video, photograph, audio, text, inertial measurement unit data, GPS data, weather data, vehicle type, vehicle sensor data, date, and time.

20. The non-transitory computer-readable device of claim 17, wherein the output comprises one or more of a three-dimensional video reconstruction of the traffic accident, an insurance claim, a news report, a traffic report, a traffic management recommendation, and emergency response communications.
